(19) United States
(12) Patent Application Publication
(10) Pub. No.: US 2017/0371321 A1
(43) Pub. Date: Dec. 28, 2017

(54) ROBOT, CONTROL DEVICE, AND ROBOT SYSTEM

(71) Applicant: Seiko Epson Corporation, Tokyo (JP)

(72) Inventors: Masaki MOTOYOSHI, Azumino (JP); Ryosuke IMAI, Matsumoto (JP)

(21) Appl. No.: 15/630,057

(22) Filed: Jun. 22, 2017

(30) Foreign Application Priority Data
Jun. 23, 2016 (JP) 2016-124230

(51) Int. Cl. G05B 19/418

(52) U.S. Cl. CPC G05B 19/41815; G05B 19/418; G05B 2219/39155; G05B 2219/31264; G05B 2219/31002; G05B 2219/39163; G05B 2219/32061

(57) ABSTRACT

A robot includes a movable section capable of moving, a driving section configured to drive the movable section, a transmitting section located between the movable section and the driving section, a first position detecting section configured to detect a position on an input side of the transmitting section, a second position detecting section configured to detect a position on an output side of the transmitting section, and an inertial sensor provided in the movable section. The driving section is driven on the basis of a detection result of the first position detecting section, a detection result of the second position detecting section, and a detection result of the inertial sensor.

### BACKGROUND

### 1. Technical Field

The present invention relates to a robot, a control device, and a robot system.

### 2. Related Art

There is known a robot including a base and a manipulator including a plurality of arms (links). One arm of adjacent two arms of the manipulator is turnably coupled to the other arm via a joint section. An arm at a most proximal end side (a most upstream side) is turnably coupled to the base via a joint section. The joint sections are driven by motors. The arms turn according to the driving of the joint sections. For example, a hand is detachably attached to an arm on a most distal end side (a most downstream side) as an end effector. For example, the robot grips a target object with the hand, moves the target object to a predetermined place, and performs predetermined work such as assembly.

JP-A-2013-833 (Patent Literature 1) discloses a robot controlled on the basis of a detection result of an angle sensor provided in a motor and a detection result of an angular velocity sensor provided in a manipulator. In the robot, it is possible to suppress vibration using the detection result of the angular velocity sensor.

A distortion amount of a reduction gear is sometimes corrected in order to improve accuracy of position in position control of the distal end portion of the manipulator. In such a case, it is necessary to integrate angular velocity detected by the angular velocity sensor and convert the angular velocity into information concerning a position.

However, an error due to offset is included in the detection result of the angular velocity sensor. When the position control is performed, if the offset is included, the offset is also integrated and accurate position information cannot be obtained. Consequently, accuracy of position is deteriorated.

### SUMMARY

An advantage of some aspects of the invention is to solve at least a part of the problems described above, and the invention can be implemented as the following forms or application examples.

A robot according to an aspect of the invention includes: a movable section capable of moving; a driving section configured to drive the movable section; a transmitting section located between the movable section and the driving section; a first position detecting section configured to detect a position on an input side of the transmitting section; a second position detecting section configured to detect a position on an output side of the transmitting section; and an inertial sensor provided in the movable section.

With this configuration, it is possible to improve accuracy of position taking into account distortion and vibration of a portion further on the distal end side than the driving section.

In the robot according to the aspect of the invention, it is preferable that the driving section is driven on the basis of a detection result of the first position detecting section, a detection result of the second position detecting section, and a detection result of the inertial sensor.

With this configuration, it is possible to improve the accuracy of position taking into account distortion and vibration of the portion further on the distal end side than the driving section.

In the robot according to the aspect of the invention, it is preferable that the inertial sensor is located further on a distal end side of the movable section than the second position detecting section.

With this configuration, it is possible to accurately detect vibration.

In the robot according to the aspect of the invention, it is preferable that, when a first displacement amount of a distal end of the movable section due to deformation of the transmitting section at a time when an external force acts on the distal end of the movable section and a second displacement amount of the distal end of the movable section due to the deformation of the movable section at the time when the external force acts on the distal end of the movable section are compared, the second displacement amount is equal to or larger than 1/30 of the first displacement amount.

This is intended to exclude excessively high rigidity of the movable section. When the rigidity of the movable section is relatively low, it is possible to markedly improve the accuracy of position.

In the robot according to the aspect of the invention, it is preferable that an abnormality of at least one of the first position detecting section, the second position detecting section, the inertial sensor, the driving section, the transmitting section, and the movable section can be detected on the basis of a detection result of the first position detecting section, a detection result of the second position detecting section, and a detection result of the inertial sensor.

It is possible to detect an abnormality of at least one of the driving section, the transmitting section, and the movable section using the detection result of the first position detecting section, the detection result of the second position detecting section, and the detection result of the inertial sensor. When the abnormality is detected, it is possible to accurately cope with the abnormality.

In the robot according to the aspect of the invention, it is preferable that the movable section includes a plurality of arms.

With this configuration, it is possible to perform various kinds of operation. Therefore, it is possible to efficiently perform various kinds of work. It is possible to improve the accuracy of position in the work.

In the robot according to the aspect of the invention, it is preferable that the transmitting section includes a reduction gear.

With this configuration, it is possible to obtain a large driving force using the driving section having a small driving force. It is possible to change driving speed of the driving section to necessary driving speed, for example, change rotational speed of the driving section to necessary rotational speed.

A control device according to an aspect of the invention controls the robot according to the aspect of the invention.

With this configuration, it is possible to improve the accuracy of position taking into account deformation and vibration of the portion further on the distal end side than the driving section.

In the control device according to the aspect of the invention, it is preferable that the control device includes: a low-pass filter provided on an output side of the second position detecting section; and a high-pass filter provided on an output side of the inertial sensor.

With this configuration, it is possible to accurately remove or reduce a noise component. It is possible to improve the accuracy of position.

In the control device according to the aspect of the invention, it is preferable that the control device includes: a calculating section configured to perform calculation on the basis of a detection result of the second position detecting section and a detection result of the inertial sensor; and a high-pass filter provided on an output side of the calculating section.

With this configuration, it is possible to accurately remove or reduce a noise component. It is possible to improve the accuracy of position.

A robot system according to an aspect of the invention includes: the robot according to the aspect of the invention; and a control device that controls the robot.

With this configuration, it is possible to improve the accuracy of position taking into account distortion and vibration of the portion further on the distal end side than the driving section.

### BRIEF DESCRIPTION OF THE DRAWINGS

The invention will be described with reference to the accompanying drawings, wherein like numbers reference like elements.

FIG. 1 is a sectional view (partially a sectional view) showing a robot system according to a first embodiment of the invention.

FIG. 2 is a block diagram of a main part of the robot system shown in FIG. 1.

FIG. 3 is a block diagram showing a configuration example of a circuit that processes outputs of an angular velocity sensor and a second angle sensor of a control section in a robot system according to a second embodiment of the invention.

FIG. 4 is a block diagram showing a configuration example of the circuit that processes outputs of the angular velocity sensor and the second angle sensor of the control section in the robot system according to the second embodiment of the invention.

FIG. 5 is a block diagram showing a configuration example of the circuit that processes outputs of the angular velocity sensor and the second angle sensor of the control section in the robot system according to the second embodiment of the invention.

FIG. 6 is a block diagram showing a configuration example of the circuit that processes outputs of the angular velocity sensor and the second angle sensor of the control section in the robot system according to the second embodiment of the invention.

FIG. 7 is a side view (partially a sectional view) showing a robot system according to a third embodiment of the invention.

FIG. 8 is a perspective view showing a robot system according to a fourth embodiment of the invention.

FIG. 9 is a schematic diagram of a robot of the robot system shown in FIG. 8.

FIG. 10 is a block diagram of a main part of the robot system shown in FIG. 8.

### DESCRIPTION OF EXEMPLARY EMBODIMENTS

A robot, a control device, and a robot system according to embodiments of the invention are explained below with reference to the accompanying drawings.

### First Embodiment

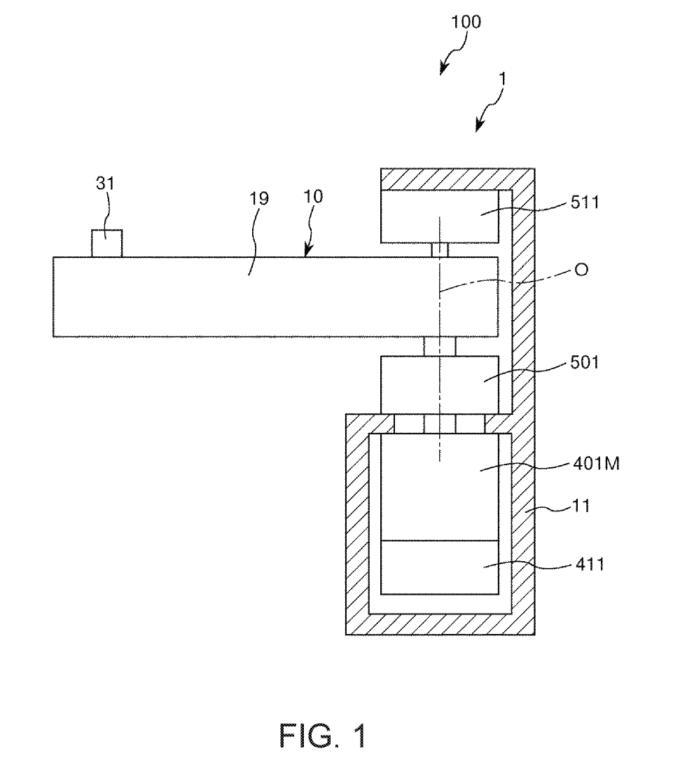

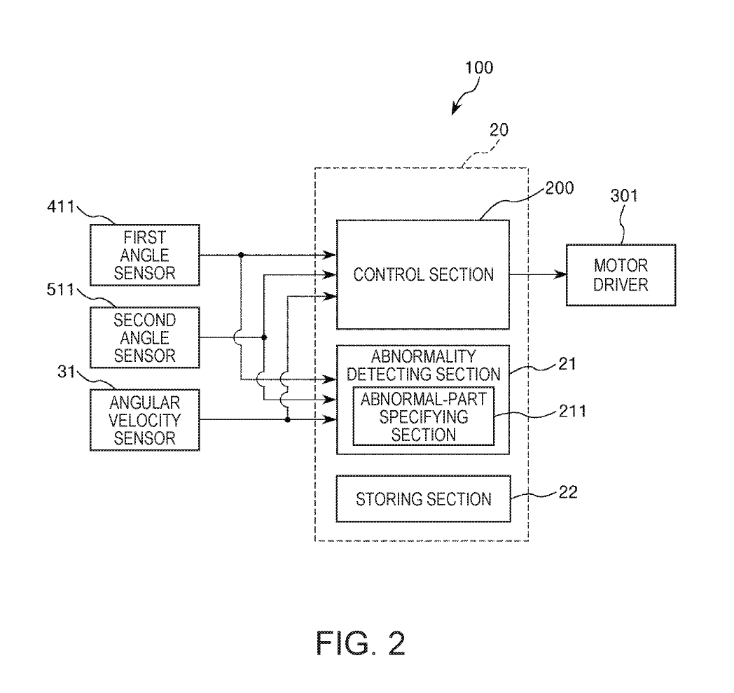

FIG. 1 is a side view (partially a sectional view) showing a robot system according to a first embodiment of the invention. FIG. 2 is a block diagram of a main part of the robot system shown in FIG. 1.

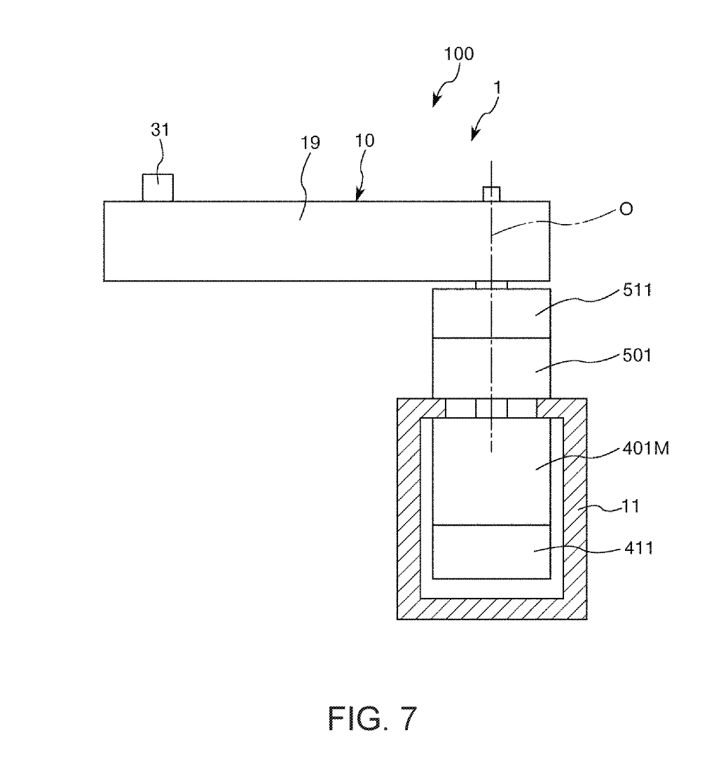

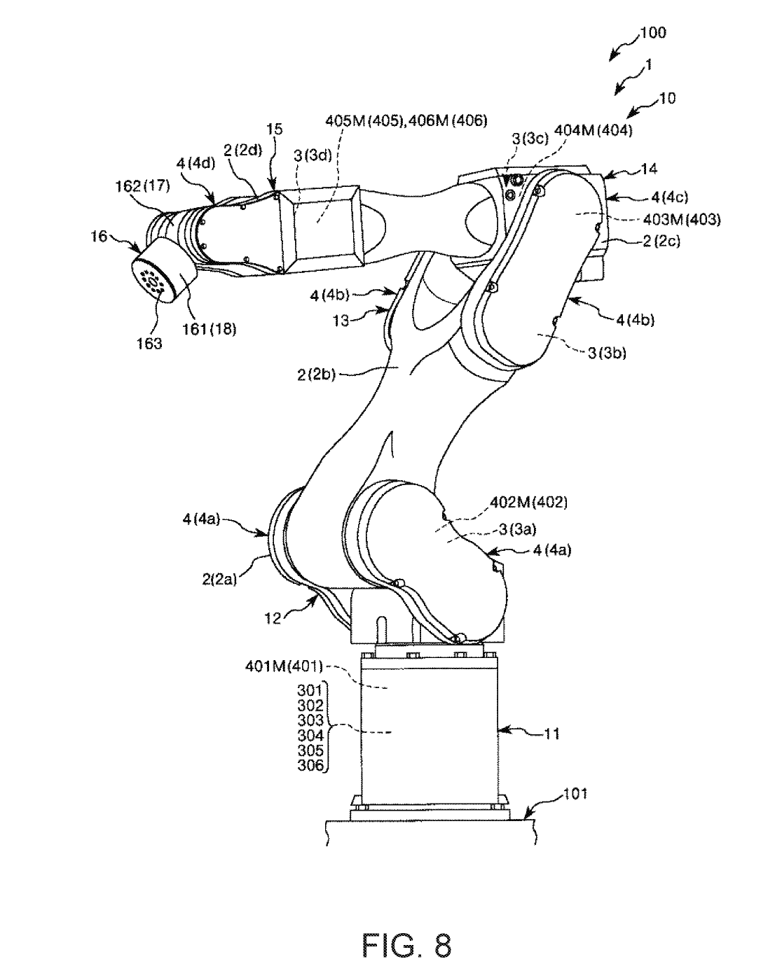

Note that, in the following explanation, for convenience of explanation, an upper side in FIG. 1 is referred to as “upper” or “upward” and a lower side in the figure is referred to as “lower” or “downward” (the same applies to FIGS. 7 and 8). A base side in FIG. 1 is referred to as “proximal end” or “upstream” and the opposite side of the base side is referred to as “distal end” or “downstream” (the same applies to FIGS. 7 and 8). An up-down direction in FIG. 1 is the vertical direction (the same applies to FIGS. 7 and 8).

A robot system 100 shown in FIGS. 1 and 2 includes a robot 1 and a control device 20 that controls the robot 1. The robot 1 includes a base 11 and a manipulator 10 (a robot arm). In this embodiment, the manipulator 10 includes, on the base 11, one arm 19 provided to be capable of turning around a turning axis O.

The control device 20 can be configured by, for example, a personal computer (PC) incorporating a CPU (Central Processing Unit). The control device 20 includes a control section 200 that controls actuation (driving) of sections of a motor 401M and the like explained below of the robot 1, an abnormality detecting section 21 that performs abnormality detection, a storing section 22 that stores various kinds of information, and the like. The abnormality detecting section includes an abnormal-part specifying section 211 that specifies an abnormal part of the robot 1. Note that a part or the entire control device 20 may be incorporated in the robot 1. The control device 20 may be separate from the robot 1. The robot 1 is explained in detail below.

The robot 1 includes an arm 19, which is an example of a movable section capable of moving, a motor 401M, which is an example of a driving section configured to drive the movable section, a motor driver 301 that drives the motor 401M, a reduction gear 501, which is an example of a transmitting section (a power transmitting section) located between the movable section and the driving section, a first angle sensor 411, which is an example of a first position detecting section configured to detect a position on an input side of the transmitting section, a second angle sensor 511, which is an example of a second position detecting section configured to detect a position on an output side of the transmitting section, and an angular velocity sensor 31, which is an example of an inertial sensor provided in the movable section.

The motor 401M is driven on the basis of a detection result of the first angle sensor 411, a detection result of the second angle sensor 511, and a detection result of the angular velocity sensor 31 according to the control by the control device 20.

Note that the movement of the movable section is not limited to movement on a straight line and a curve and is, for example, a concept including all movements (displacements) such as turning. The position includes an angle (a rotation angle).

The input side of the transmitting section refers to a driving section side of the transmitting section. In this embodiment, the input side of the transmitting section is an input shaft of the reduction gear 501. A rotation angle of the input shaft of the reduction gear 501 is the same as a rotation angle of a rotating shaft of the motor 401M. Therefore, in this embodiment, the rotation angle of the rotating shaft of the motor 401M is detected as a position on the input side of the transmitting section.

The output side of the transmitting section refers to a side of the transmitting section opposite to the driving section, that is, a movable section side of the transmitting section. In this embodiment, the output side of the transmitting section is an output shaft of the reduction gear 501. A rotation angle of the output shaft of the reduction gear 501 is the same as a rotation angle of the proximal end portion of the arm 19. In this embodiment, the rotation angle of the output shaft of the reduction gear 501 is detected as a position on the output side of the transmitting section.

The base 11 is a portion fixed (set) on, for example, a floor of a setting space. A method of fixing the base 11 is not particularly limited. Examples of the method include a fixing method by a plurality of bolts.

The proximal end portion of the arm 19 is coupled to the base 11. The arm 19 has the turning axis O extending along the vertical direction, that is, the turning axis O parallel to the vertical direction as a turning center and is capable of turning around the turning axis O with respect to the base 11. Note that, for example, in the case of two axes, “parallel” not only indicates that the two axes are completely parallel but also indicates that one axis inclines within a range of ±5° or less with respect to the other axis.

The motor 401M, which is a driving section that turns the arm 19, and the reduction gear 501 are set in the base 11. The motor 401M and the reduction gear 501 are fixed to the base 11. The input shaft of the reduction gear 501 is coupled to the rotating shaft of the motor 401M. The output shaft of the reduction gear 501 is coupled to the arm 19. Therefore, when the motor 401M is driven and a driving force of the motor 401M is transmitted to the arm 19 via the reduction gear 501, the arm 19 turns within a horizontal plane around the turning axis O with respect to the base 11.

The motor 401M is not particularly limited. It is desirable to use a servomotor such as an AC servomotor or a DC servomotor.

The reduction gear 501 is not particularly limited. Examples of the reduction gear 501 include a strain wave gearing, that is, a harmonic drive (“harmonic drive” is a registered trademark), and a gear reducer.

Note that, in this embodiment, the transmitting section is a power transmitting section that transmits power. The transmitting section is configured by the reduction gear 501. However, the transmitting section may include other members besides the reduction gear 501. That is, the transmitting section only has to be configured by a mechanism including the reduction gear 501. Consequently, it is possible to obtain a large driving force using the motor 401M having a small driving force. It is possible to change the rotational speed of the motor 401M to necessary rotational speed. Note that the transmitting section may be configured by a mechanism not having a speed reducing function.

The rigidity of the arm 19, the reduction gear 501, and the like is not particularly limited. When a first displacement amount of the distal end of the arm 19 due to deformation of the reduction gear 501 at the time when an external force acts on the distal end of the arm 19 and a second displacement amount of the distal end of the arm 19 due to deformation of the arm 19 at the time when the same external force acts on the distal end of the arm 19 are compared, the second displacement amount is desirably equal to or larger than 1/30 of the first displacement amount. This is intended to exclude excessively high rigidity of the arm 19. When the rigidity of the arm 19 is relatively low, it is possible to markedly improve accuracy of position.

The second displacement amount is more desirably equal to or larger than 1/30 of the first displacement amount and equal to or smaller than 30 and still more desirably equal to or larger than 1/10 of the first displacement amount and equal to or smaller than 10.

In the motor 401M, a first angle sensor 411 that detects a rotation angle (a rotation amount) of the rotating shaft of the motor 401M with respect to the base 11 is set. It is possible to detect the rotation angle of the rotating shaft of the motor 401M with respect to the base 11, that is, a rotation angle of the input shaft of the reduction gear 501 on the basis of a detection result (an output) of the first angle sensor 411. In the following explanation, the rotation angle of the rotating shaft of the motor 401M is also referred to as rotation angle of the motor 401M.

Note that, in this embodiment, the motor 401M, the reduction gear 501, and the first angle sensor 411 are disposed below the arm 19.

In the base 11, the second angle sensor 511 that detects a rotation angle of the output shaft of the reduction gear 501 with respect to the base 11 is set. It is possible to detect the rotation angle of the output shaft of the reduction gear 501 with respect to the base 11, that is, a rotation angle of the arm 19 on the basis of a detection result of the second angle sensor 511. In this embodiment, the second angle sensor 511 is disposed above the arm 19.

The first angle sensor 411 and the second angle sensor 511 are not particularly limited. Examples of each of the first and second angle sensors 411, 511 include an encoder, a resolver, and a potentiometer.

The angular velocity sensor 31 is set in the arm 19. The position of the angular velocity sensor 31 in the arm 19 is not particularly limited. However, in this embodiment, the angular velocity sensor 31 is located further on the distal end side of the arm 19 than the second angle sensor 511. That is, the angular velocity sensor 31 is disposed at the distal end portion of the arm 19. Consequently, it is possible to accurately detect, with the angular velocity sensor 31, angular velocity due to vibration of the arm 19.

The inertial sensor is not limited to the angular velocity sensor. Examples of the inertial sensor include an acceleration sensor. In this embodiment, one angular velocity sensor 31 is provided. However, a plurality of angular velocity sensors 31 may be provided.

A not-shown end effector can be detachably attached to the distal end portion of the arm 19. The end effector is not particularly limited. Examples of the end effector include an end effector that grips a target object and an end effector that machines a target object.

In operating the robot 1, the control device 20 performs detection with the first angle sensor 411, the second angle sensor 511, and the angular velocity sensor 31 and controls the driving of the motor 401M on the basis of results of the detection. Note that it is possible to calculate a rotation angle due to vibration on the basis of the detection result of the first angle sensor 411 and the detection result of the second angle sensor 511. It is possible to calculate angular velocity due to vibration on the basis of the detection result of the first angle sensor 411 and the detection result of the angular velocity sensor 31. Examples of the control of the robot 1 include position control, speed control, force control, and damping control. Note that a control program is stored in advance in the storing section 22 of the control device 20.

In the robot system 100, it is possible to detect an abnormality of a predetermined portion of the robot 1, that is, at least one of the first angle sensor 411, the second angle sensor 511, the angular velocity sensor 31, the motor 401M, the reduction gear 501, and the arm 19 on the basis of the detection result of the first angle sensor 411, the detection result of the second angle sensor 511, and the detection result of the angular velocity sensor 31. The abnormality detection is performed by the abnormality detecting section 21 of the control device 20. In the abnormality detection, an abnormal part of the robot 1 is specified by the abnormal-part specifying section 211 of the abnormality detecting section 21. The abnormality detection is explained below.

The abnormality detection includes three kinds of processing (1) to (3). The abnormality detecting section 21 performs two or more kinds of processing among the three kinds of processing. The abnormality detecting section 21 specifies an abnormal part using a result of the processing.

(1) The abnormality detecting section 21 compares a value obtained by dividing an output value of the first angle sensor 411 by a reduction gear ratio of the reduction gear 501 and an output value of the second angle sensor 511.

(2) The abnormality detecting section 21 compares a differential value of the value obtained by dividing the output value of the first angle sensor 411 by the reduction gear ratio of the reduction gear 501 and an output value of the angular velocity sensor 31.

(3) The abnormality detecting section 21 compares a differential value of the output value of the second angle sensor 511 and the output value of the angular velocity sensor 31.

In each of the kinds of processing (1) to (3), the abnormality detecting section 21 determines whether the values are the same as a result of performing the comparison. “The same” is not limited to complete equality of the values and includes values having a difference in a degree of an error, for example, a difference of ±5% or less. The error is not limited to a ratio of the values and may be a fixed value. For example, ±5% of maximum speed may be set as an allowable error. Note that a numerical value of “±5%” can be set as appropriate according to conditions. In the following explanation, as a result of performing the comparison, when the values are the same, the values are simply referred to as “the same” and, when the values are different, the values are simply referred to as “different”.

In the abnormality detection, according to which of the values is “different” or which of the values is “the same”, it is possible to determine whether there is an abnormality and, when there is an abnormality, which part is an abnormal part. The abnormality detection is specifically explained with reference to Table 1 below.

TABLE 1

| | | | | Determination during comparison | | |
|---|---|---|---|---|---|---|
| | | | | (1) First | (2) First | (3) Second |
| | | | | angle | angle | angle |
| | Influence | | | sensor and | sensor and | sensor and |
| Ab- | First | Second | Angular | second | angular | angular |
| normal | angle | angle | velocity | angle | velocity | velocity |
| part | sensor | sensor | sensor | sensor | sensor | sensor |
| First | Yes | No | No | Different | Different | Same |
| angle | | | | | | |
| sensor | | | | | | |
| Re- | No | Yes | Yes | Different | Different | Same |
| duction | | | | | | |
| gear | | | | | | |
| Second | No | Yes | No | Different | Same | Different |
| angle | | | | | | |
| sensor | | | | | | |
| Arm | No | No | Yes | Same | Different | Different |
| Angular | No | No | Yes | Same | Different | Different |
| velocity | | | | | | |
| sensor | | | | | | |

First, as shown in Table 1, when the abnormal part is the first angle sensor 411, only the first angle sensor 411 is affected.

When the abnormal part is the reduction gear 501, the second angle sensor 511 and the angular velocity sensor 31 are affected. The first angular sensor 411 is not affected.

When the abnormal part is the second angle sensor 511, only the second angle sensor 511 is affected.

When the abnormal part is the arm 19, only the angular velocity sensor 31 is affected.

When the abnormal part is the angular velocity sensor 31, only the angular velocity sensor 31 is affected.

When the relation explained above is taken into account, it is possible to detect an abnormality and specify a part of the abnormality by performing two or more kinds of processing among the kinds of processing (1) to (3) and using a result of the processing.

First, abnormality detection performed by the kinds of processing (1) and (2) is explained.

When determining “different” in the respective kinds of processing (1) and (2), the abnormality detecting section 21 determines that at least one of the first angle sensor 411 and the reduction gear 501 is abnormal.

When determining “different” only in the processing (1), the abnormality detecting section 21 determines that the second angle sensor 511 is abnormal.

When determining “different” only in the processing (2), the abnormality detecting section 21 determines that at least one of the angular velocity sensor 31 and the arm 19 is abnormal.

Abnormality detection performed by the kinds of processing (1) and (3) is explained.

When determining “different” only in the processing (1), the abnormality detecting section 21 determines that at least one of the first angle sensor 411 and the reduction gear 501 is abnormal.

When determining “different” in the respective kinds of processing (1) and (3), the abnormality detecting section 21 determines that the second angle sensor 511 is abnormal.

When determining “different” only in the processing (3), the abnormality detecting section 21 determines that at least one of the angular velocity sensor 31 and the arm 19 is abnormal.

Abnormality detection performed by the kinds of processing (2) and (3) is explained.

When determining “different” only in the processing (2), the abnormality detecting section 21 determines that at least one of the first angle sensor 411 and the reduction gear 501 is abnormal.

When determining “different” only in the processing (3), the abnormality detecting section 21 determines that the second angle sensor 511 is abnormal.

When determining “different” in the respective kinds of processing (2) and (3), the abnormality detecting section 21 determines that at least one of the angular velocity sensor 31 and the arm 19 is abnormal.

As explained above, it is possible to detect an abnormality by performing two kinds of processing among the kinds of processing (1) to (3) and using a result of the processing. However, an abnormality may be detected by performing all of the kinds of processing (1) to (3) and using a result of the processing. In this case, when there is an abnormality in one part, the number of “different” is always two (an even umber) in the kinds of processing (1) to (3). Therefore, when the number of “different” is one or three (an odd number) in the kinds of processing (1) to (3), the abnormality detecting section 21 determines that abnormalities are likely to be present in a plurality of parts.

In the following explanation, the abnormality detection is performed using the detection results of all of the first angle sensor 411, the second angle sensor 511, and the angular velocity sensor 31, in the embodiment, the differential value of the value obtained by dividing the output value of the first angle sensor 411 by the reduction gear ratio of the reduction gear 501, the differential value of the output value of the second angle sensor 511, and the output value of the angular speed sensor 31. The differential value of the value obtained by dividing the output value of the first angle sensor 411 by the reduction gear ratio of the reduction gear 501 is simply referred to as “converted value of the first angle sensor 411”. The differential value of the output value of the second angle sensor 511 is simply referred to as “converted value of the second angle sensor 511”.

First, when there is an abnormality in any one part of the robot 1, only one value of the converted value of the first angle sensor 411, the converted value of the second angle sensor 511, and the output value of the angular velocity sensor 31 is greatly different compared with the other two values. Therefore, dispersion of the converted value of the first angle sensor 411, the converted value of the second angle sensor 511, and the output value of the angular velocity sensor 31 is large. Therefore, the abnormality detecting section 21 calculates the dispersion and compares the dispersion with a threshold set in advance. When the dispersion is larger than the threshold, the abnormality detecting section 21 determines that there is an abnormality in any one part of the robot 1. When the dispersion is equal to or smaller than the threshold, the abnormality detecting section 21 determines that the sensors are normal. Note that a standard deviation may be used instead of the dispersion.

When there is an abnormality, the sensor having the largest difference from an average or the vicinity of the sensor is an abnormal part. The abnormality detection is specifically explained with reference to Table 2 below.

TABLE 2

| | First | Second | Angular | | |
|---|---|---|---|---|---|
| | angle | angle | velocity | | |
| | sensor | sensor | sensor | | |
| | [deg/sec] | [deg/sec] | [deg/sec] | Dispersion | Determination |
| Scene 1 | 100 | 98 | 101 | 2.33 | Normal |
| Scene 2 | 100 | 98 | 0 | 3268 | Abnormal |
| Scene 3 | 31 | 30 | 31 | 0.333 | Normal |
| Scene 4 | 30 | 500 | 31 | 73320 | Abnormal |

First, scenes shown in Table 2 are explained. In a scene 1 and a scene 3, the robot 1 is normal. In a scene 2, there is an abnormality in the angular velocity sensor 31 or the vicinity of the angular velocity sensor 31. In a scene 4, there is an abnormality in the second angle sensor 511 or the vicinity of the second angle sensor 511. Before the abnormality detection is performed, this information is not known.

The abnormality detection is explained below with reference to such a case as an example. Note that, in the abnormality detection, as an example, the threshold is set to “100”.

In the scene 1, the dispersion is small. When the dispersion and the threshold “100” are compared, the dispersion is equal to or smaller than the threshold. The abnormality detecting section 21 determines that the sensors are normal.

In the scene 2, the dispersion is large. When the dispersion and the threshold “100” are compared, the dispersion is larger than the threshold. The abnormality detecting section 21 determines that there is an abnormality. A difference between the output value of the angular velocity sensor 31 and the average is the largest. Therefore, the abnormality detecting section 21 determines that an abnormal part is the angular velocity sensor 31 or the vicinity of the angular velocity sensor 31.

In the scene 3, the dispersion is small. When the dispersion and the threshold “100” are compared, the dispersion is equal to or smaller than the threshold. The abnormality detecting section 21 determines that the sensors are normal.

In the scene 4, the dispersion is large. When the dispersion and the threshold “100” are compared, the dispersion is larger than the threshold. The abnormality detecting section 21 determines that there is an abnormality. A difference between the converted value of the second angle sensor 511 and the average is the largest. Therefore, the abnormality detecting section 21 determines that an abnormal part is the second angle sensor 511 or the vicinity of the second angle sensor 511.

As explained above, in the robot system 100, it is possible to improve the accuracy of position taking into account distortion and vibration of a portion further on the distal end side than the motor 401M. It is possible to suppress the vibration.

With the abnormality detecting section 21, it is possible to detect an abnormality concerning the reduction gear 501, the arm 19, the first angle sensor 411, the second angle sensor 511, and the angular velocity sensor 31 and specify an abnormal part. When an abnormality is detected, it is possible to accurately cope with the abnormality by, for example, stopping the robot 1, replacing components, and performing repairing.

### Second Embodiment

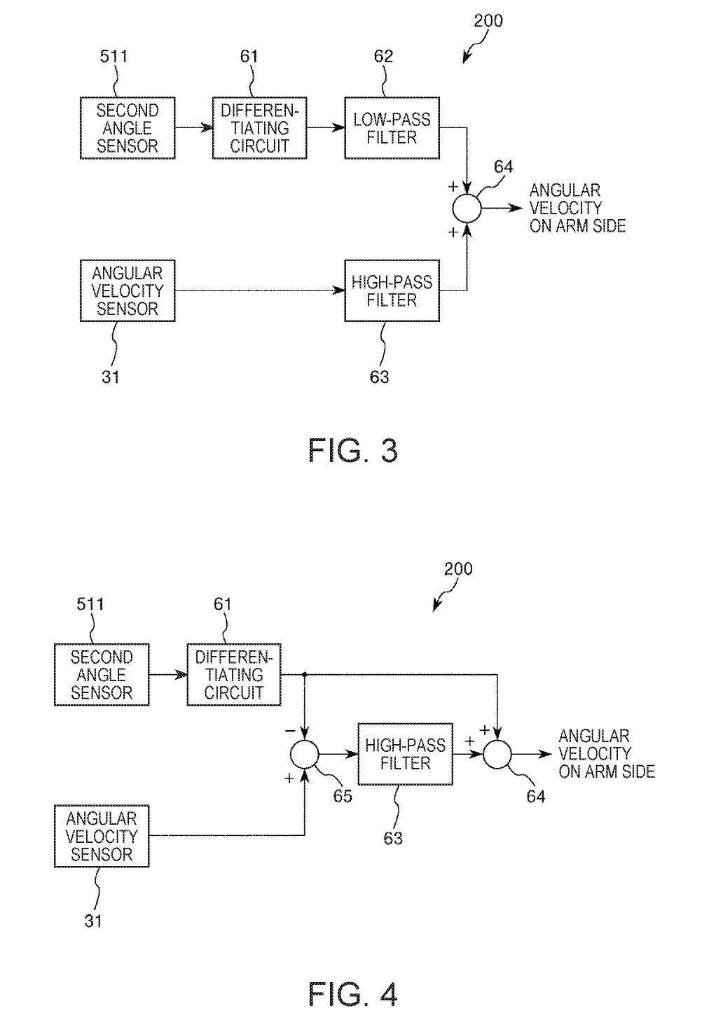

FIGS. 3 to 6 are respectively block diagrams showing configuration examples of a circuit that processes outputs of an angular velocity sensor and a second angle sensor of a control section of a robot system according to the second embodiment of the invention.

The second embodiment is explained below. Differences from the first embodiment are mainly explained. Explanation of similarities is omitted.

First, before the explanation of the second embodiment, it is checked what the first angle sensor 411, the second angle sensor 511, and the angular velocity sensor 31 respectively detect.

The first angle sensor 411 detects a rotation angle corresponding to a target motion of the arm 19.

The second angle sensor 511 detects the rotation angle corresponding to the target motion of the arm 19 and a rotation angle due to vibration of the reduction gear 501.

The angular velocity sensor 31 detects angular velocity corresponding to the target motion of the arm 19, angular velocity due to vibration of the arm 19, and angular velocity due to the vibration of the reduction gear 501. Offset is included in an output value of the angular velocity sensor 31.

A configuration example of a circuit that calculates angular velocity on the arm 19 side on the basis of detection results of the second angle sensor 511 and the angular velocity sensor 31 in the control section 200 is explained. The angular velocity on the arm 19 side is angular velocity obtained by combining the angular velocity corresponding to the target motion of the arm 19, the angular velocity due to the vibration of the arm 19, and the angular velocity due to the vibration of the reduction gear 501.

### Configuration Example 1

As shown in FIG. 3, the control section 200 includes a low-pass filter 62 provided an output side of the second angle sensor 511 and a high-pass filter 63 provided on an output side of the angular velocity sensor 31. This configuration example is specifically explained below.

The control section 200 includes a differentiating circuit 61, the low-pass filter 62, the high-pass filter 63, and an adder 64.

The differentiating circuit 61 is connected to the output side of the second angle sensor 511. The low-pass filter 62 is connected to the output side of the differential circuit 61. The high-pass filter 63 is connected to the output side of the angular velocity sensor 31. The adder 64 is connected to output sides of the low-pass filter 62 and the high-pass filter 63.

In this circuit, an output of the second angle sensor 511, that is, a signal indicating a rotation angle detected by the second angle sensor 511 is converted from an analog signal into a digital signal by a not-shown AD converter and thereafter converted into a signal indicating angular velocity by the differentiating circuit 61. The signal is processed by the low-pass filter 62. A high-frequency component is removed or reduced.

An output of the angular velocity sensor 31, that is, a signal indicating angular velocity detected by the angular velocity sensor 31 is converted from an analog signal into a digital signal by a not-shown AD converter and thereafter processed by the high-pass filter 63. A low-frequency component is removed or reduced.

The signal output from the low-pass filter 62 and the signal output from the high-pass filter 63 are added up by the adder 64 and an added-up signal is output. This signal is a signal indicating angular velocity on the arm 19 side.

It is explained what kinds of information are mainly included in the signals.

First, the signal output from the second angle sensor 511 is a signal including information concerning the rotation angle corresponding to the target motion of the arm 19 and information concerning the rotation angle due to the vibration of the reduction gear 501.

The signal output from the low-pass filter 62 is a signal including information concerning a low-frequency component of the angular velocity corresponding to the target motion of the arm 19 and information concerning angular velocity due to primary mode vibration in the vibration of the reduction gear 501. Information concerning a high-frequency component of the angular velocity corresponding to the target motion of the arm 19 and information concerning angular velocity due to secondary mode vibration in the vibration of the reduction gear 501 are removed by the low-pass filter 62.

The signal output from the angular velocity sensor 31 is a signal including information concerning the angular velocity corresponding to the target motion of the arm 19, information concerning the angular velocity due to the vibration of the arm 19, information concerning the angular velocity due to the vibration of the reduction gear 501, and information concerning offset.

The signal output from the high-pass filter 63 is a signal including the information concerning a high-frequency component of the angular velocity corresponding to the target motion of the arm 19, information concerning an angular velocity due to secondary mode vibration in the vibration of the arm 19, and the information concerning the angular velocity due to the secondary mode vibration in the vibration of the reduction gear 501. Note that the information concerning the low-frequency component of the angular velocity corresponding to the target motion of the arm 19, the information concerning the angular velocity due to the primary mode vibration in the vibration of the arm 19, the information concerning the angular velocity due to the primary mode vibration in the vibration of the reduction gear 501, and the information concerning the offset are removed by the high-pass filter 63.

The signal indicating the angular velocity on the arm 19 side output from the adder 64 is a signal including the information concerning the angular velocity corresponding to the target motion of the arm 19 and information concerning angular velocity due to the primary mode vibration and the secondary mode vibration concerning the arm 19 and the reduction gear 501. Note that a phase of the primary mode vibration of the reduction gear 501 detected by the second angle sensor 511 and a phase of the primary mode vibration of the arm 19 detected by the angular velocity sensor 31 are the same phase. Therefore, the information concerning the angular velocity due to the primary mode vibration of the arm 19 is complemented by the information concerning the angular velocity due to the primary mode vibration of the reduction gear 501 output from the low-pass filter 62.

In the configuration example 1, it is possible to respectively use highly accurate portions concerning the outputs of the second angle sensor 511 and the angular velocity sensor 31. It is possible to accurately remove or reduce a noise component. It is possible to accurately operate the robot 1 by controlling the robot 1 using an output of the circuit.

### Configuration Example 2

As shown in FIG. 4, the control section 200 includes a subtracter 65, which is an example of a calculating section that performs calculation on the basis of the detection result of the second angle sensor 511 and the detection result of the angular velocity sensor 31 and the high-pass filter 63 provided on an output side of the subtracter 65. This configuration example is specifically explained below.

The control section 200 includes the differentiating circuit 61, the subtracter 65, the high-pass filter 63, and the adder 64.

The differentiating circuit 61 is connected to the output side of the second angle sensor 511. The subtracter 65 is connected to the output sides of the differentiating circuit 61 and the angular velocity sensor 31. The high-pass filter 63 is connected to the output side of the subtracter 65. The adder 64 is connected to the output sides of the differentiating circuit 61 and the high-pass filter 63.

In this circuit, the output of the second angle sensor 511, that is, the signal indicating the rotation angle detected by the second angle sensor 511 is converted from an analog signal into a digital signal by a not-shown AD converter and thereafter converted into a signal indicating angular velocity by the differentiating circuit 61.

The output of the angular velocity sensor 31, that is, the signal indicating the angular velocity detected by the angular velocity sensor 31 is converted from an analog signal into a digital signal by a not-shown AD converter. The signal output from the differentiating circuit 61 is subtracted from the converted signal by the subtracter 65. The signal output from the subtracter 65 is processed by the high-pass filter 63. A low-frequency component is removed or reduced.

The signal output from the differentiating circuit 61 and the signal output from the high-pass filter 63 are added up by the adder 64 and an added-up signal is output. This signal is a signal indicating angular velocity on the arm 19 side.

It is explained what kinds of information are mainly included in the signals.

First, the signal output from the second angle sensor 511 is a signal including the information concerning the rotation angle corresponding to the target motion of the arm 19 and the information concerning the rotation angle due to the vibration of the reduction gear 501.

The signal output from the angular velocity sensor 31 is a signal including the information concerning the angular velocity corresponding to the target motion of the arm 19, the information concerning the angular velocity due to the vibration of the arm 19, the information concerning the angular velocity due to the vibration of the reduction gear 501, and the information concerning the offset.

The signal output from the subtracter 65 is a signal including the information concerning the angular velocity due to the vibration of the arm 19 and the information concerning the offset.

The signal output from the high-pass filter 63 is a signal including the information concerning the angular velocity due to the vibration of the arm 19. Note that the information concerning the offset is removed by the high-pass filter 63.

The signal indicating the angular velocity on the arm 19 side output from the adder 64 is a signal including the information concerning the angular velocity corresponding to the target motion of the arm 19, the information concerning the angular velocity due to the vibration of the arm 19, and the information concerning the angular velocity due to the vibration of the reduction gear 501.

In the configuration example 2, the number of filters is small compared with the configuration example 1. Therefore, there is an advantage that computational complexity is small. In the configuration example 2, an effect same as the effect in the configuration example 1 is obtained.

A configuration example of a circuit that calculates a rotation angle on the arm 19 side on the basis of the detection results of the second angle sensor 511 and the angular velocity sensor 31 in the control section 200 is explained. The rotation angle on the arm 19 side is a rotation angle obtained by combining the rotation angle corresponding to the target motion of the arm 19, the rotation angle due to the vibration of the arm 19, and the rotation angle due to the vibration of the reduction gear 501.

### Configuration Example 3

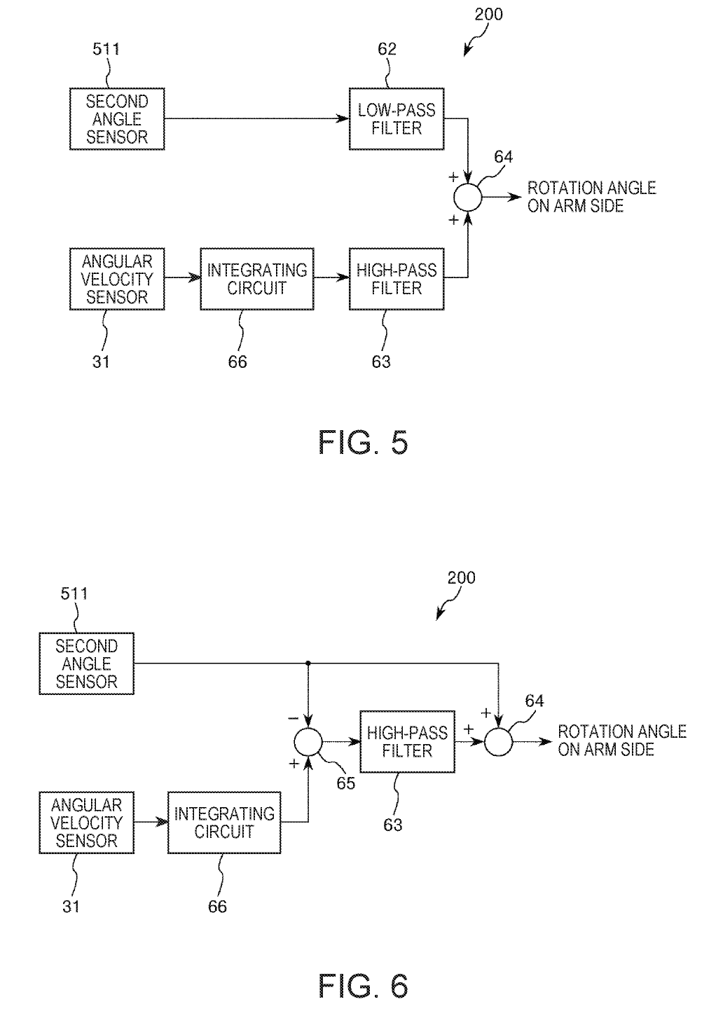

As shown in FIG. 5, the control section 200 includes an integrating circuit 66, the low-pass filter 62, the high-pass filter 63, and the adder 64. In the configuration example 3, the differentiating circuit 61 is omitted and the integrating circuit 66 is provided in the configuration example 1. Therefore, a part of explanation of the configuration example 3 is omitted.

The low-pass filter 62 is connected to the output side of the second angle sensor 511. The integrating circuit 66 is connected to the output side of the angular velocity sensor 31. The high-pass filter 63 is connected to an output side of the integrating circuit 66. The adder 64 is connected to the output sides of the low-pass filter 62 and the high-pass filter 63.

In this circuit, an output of the second angle sensor 511, that is, a signal indicating the rotation angle detected by the second angle sensor 511 is converted from an analog signal into a digital signal by a not-shown AD converter and thereafter processed by the low-pass filter 62. A high-frequency component is removed or reduced.

An output of the angular velocity sensor 31, that is, a signal indicating the angular velocity detected by the angular velocity sensor 31 is converted from an analog signal into a digital signal by a not-shown AD converter and thereafter converted into a signal indicating a rotation angle by the integrating circuit 66. The signal is processed by the high-pass filter 63. A low-frequency component is removed or reduced.

The signal output from the low-pass filter 62 and the signal output from the high-pass filter 63 are added up by the adder 64 and output. This signal is a signal indicating a rotation angle on the arm 19 side.

In this configuration example 3, it is possible to respectively use highly accurate portions concerning the outputs of the second angle sensor 511 and the angular velocity sensor 31. It is possible to accurately operate the robot 1 by controlling the robot 1 using an output of the circuit.

### Configuration Example 4

As shown in FIG. 6, the control section 200 includes the integrating circuit 66, the subtracter 65, the high-pass filter 63, and the adder 64. In the configuration example 4, the differentiating circuit 61 is omitted and the integrating circuit 66 is provided in the configuration example 2. Therefore, a part of explanation of the configuration example 4 is omitted.

The integrating circuit 66 is connected to the output side of the angular velocity sensor 31. The subtracter 65 is connected to the output sides of the integrating circuit 66 and the second angle sensor 511. The high-pass filter 63 is connected to the output side of the subtracter 65. The bypass filter 63 is connected to the outputs side of the subtracter 65. The adder 64 is connected to the output sides of the second angle sensor 511 and the high-pass filter 63.

In this circuit, an output of the second angle sensor 511, that is, a signal indicating the rotation angle detected by the second angle sensor 511 is converted from an analog signal into a digital signal by a not-shown AD converter.

An output of the angular velocity sensor 31, that is, a signal indicating the angular velocity detected by the angular velocity sensor 31 is converted from an analog signal into a digital signal by a not-shown AD converter and thereafter converted into a signal indicating a rotation angle by the integrating circuit 66. The signal output from the second angle sensor 511 is subtracted from the converted signal by the subtracter 65. The signal output from the subtracter 65 is processed by the high-pass filter 63. A low-frequency component is removed or reduced.

The signal output from the second angle sensor 511 and the signal output from the high-pass filter 63 are added up by the adder 64 and an added-up signal is output. This signal is a signal indicating a rotation angle on the arm 19 side.

In the configuration example 4, compared with the configuration example 3, the number of filters is small. Therefore, there is an advantage that computational complexity is small. In the configuration example 4, an effect same as the effect in the configuration example 3 is obtained.

The robot 1 is controlled on the basis of the angular velocity on the arm 19 side, the rotation angle on the arm 19 side, and the like calculated by the circuits in the configuration examples 1 to 4. Consequently, it is possible to accurately operate the robot 1.

According to the second embodiment explained above, it is possible to exhibit an effect same as the effect in the first embodiment.

### Third Embodiment

FIG. 7 is a side view (partially a sectional view) showing a robot system according to a third embodiment of the invention.

The third embodiment is explained below. Differences from the embodiments explained above are mainly explained. Explanation of similarities is omitted.

As shown in FIG. 7, in the third embodiment, the second angle sensor 511 is disposed below the arm 19 and set on the reduction gear 501. Therefore, all of the motor 401M, the reduction gear 501, the first angle sensor 411, and the second angle sensor 511 are located on the same side with respect to the arm 19, that is, below the arm 19. Consequently, it is possible to reduce the dimension of the base 11. It is possible to achieve a reduction in the size of the robot 1.

According to the third embodiment explained above, it is possible to exhibit an effect same as the effect in the embodiments explained above.

### Fourth Embodiment

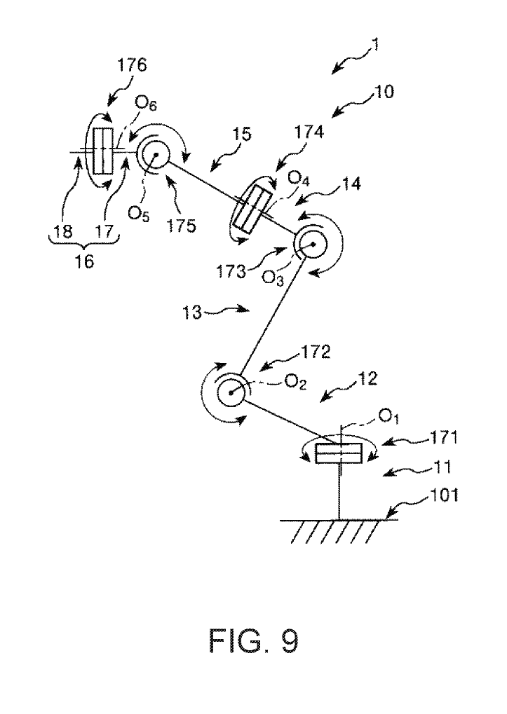

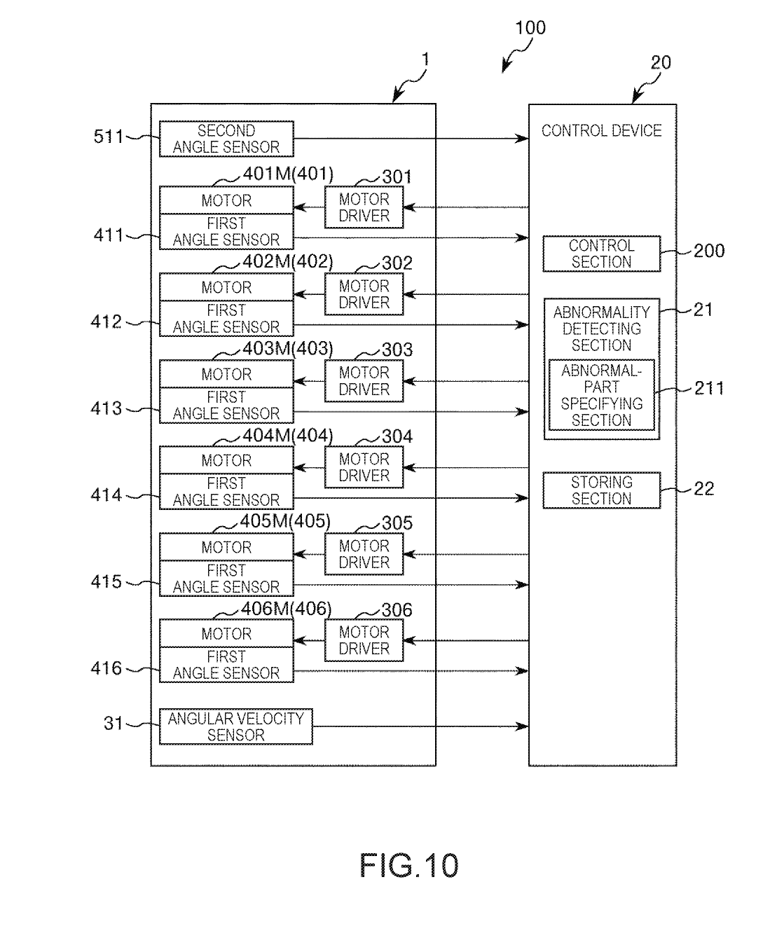

FIG. 8 is a perspective view showing a robot system according to a fourth embodiment of the invention. FIG. 9 is a schematic diagram of the robot system shown in FIG. 8. FIG. 10 is a block diagram of a main part of the robot system shown in FIG. 8.

The fourth embodiment is explained below. Differences from the embodiments explained above are mainly explained. Explanation of similarities is omitted.

In the fourth embodiment, a movable section includes a plurality of arms. Consequently, it is possible to perform various kinds of operation. Therefore, it is possible to efficiently perform various kinds of work. Note that each of the plurality of arms can be defined as the movable section. The fourth embodiment is specifically explained below.

In the fourth embodiment shown in FIGS. 8 to 10, the robot 1 includes the base 11 and the manipulator 10 (the robot arm).

The manipulator 10 includes a plurality of, in this embodiment, six arms provide to be capable of turning around a turning axis. That is, the manipulator 10 includes a first arm 12, a second arm 13, a third arm 14, a fourth arm 15, a fifth arm 17, and a sixth arm 18, a first driving source 401, a second driving source 402, a third driving source 403, a fourth driving source 404, a fifth driving source 405, and a sixth driving source 406. A wrist 16 is configured by the fifth arm 17 and the sixth arm 18. An end effector (not shown in the figure) such as a hand is detachably attached to the distal end portion of the sixth arm 18, that is, a distal end face 163 of the wrist 16. The robot 1 can perform various kinds of work such as conveyance of a precision instrument, a component, or the like by controlling the motions of the arms 12 to 15, the wrist 16, and the like, for example, while keeping gripping the precision instrument, the component, or the like with a hand. The robot 1 is explained in detail below.

The robot 1 is a vertical multi-joint (six-axis) robot in which the base 11, the first arm 12, the second arm 13, the third arm 14, the fourth arm 15, the fifth arm 17, and the sixth arm 18 are coupled in this order from the proximal end side to the distal end side. In the following explanation, the first arm 12, the second arm 13, the third arm 14, the fourth arm 15, the fifth arm 17, the sixth arm 18, and the wrist 16 are respectively referred to as “arms” as well. The first driving source 401, the second driving source 402, the third driving source 403, the fourth driving source 404, the fifth driving source 405, and the sixth driving source 406 are respectively referred to as “driving sources” as well.

The base 11 and the first arm 12 are coupled via a joint 171. The first arm 12 has a first turning axis O1 extending along the vertical direction as a turning center and is capable of turning around the first turning axis O1 with respect to the base 11. The first turning axis O1 coincides with the normal of the upper surface of a floor 101, which is a setting surface of the base 11. The first turning axis O1 is a turning axis present on a most upstream side of the robot 1. The first arm 12 is turned by driving of the first driving source 401 including the motor (the first motor) 401M and a reduction gear (not shown in the figure). The motor 401M is controlled by the control device 20 via the motor driver 301.

The first arm 12 and the second arm 13 are coupled via a joint 172. The second arm 13 has a second turning axis O2 parallel to the horizontal direction as a turning center and is capable of turning around the second turning axis O2 with respect to the first arm 12. The second turning axis O2 is orthogonal to the first turning axis O1. The second arm 13 is turned by driving of the second driving source 402 including a motor (a second moor) 402M and a reduction gear (not shown in the figure). The motor 402M is controlled by the control device 20 via a motor driver 302. Note that the second turning axis O2 may be parallel to an axis orthogonal to the first turning axis O1.

The second arm 13 and the third arm 14 are coupled via a joint 173. The third arm 14 has a third turning axis O3 parallel to the horizontal direction as a turning center and is capable of turning around the third turning axis O3 with respect to the second arm 13. The third turning axis O3 is parallel to the second turning axis O2. The third arm 14 is turned by driving of the third driving source 403 including a motor (a third motor) 403M and a reduction gear (not shown in the figure). The motor 403M is controlled by the control device 20 via a motor driver 303.

The third arm 14 and the fourth arm 15 are coupled via a joint 174. The fourth arm 15 has a fourth turning axis O4 parallel to a center axis direction of the third arm 14 as a turning center and is capable of turning around the fourth turning axis O4 with respect to the third arm 14. The fourth turning axis O4 is orthogonal to the third turning axis O3. The fourth arm 15 is turned by driving of the fourth driving source 404 including a motor (a fourth motor) 404M and a reduction gear (not shown in the figure). The motor 404M is controlled by the control device 20 via a motor driver 304. Note that the fourth turning axis O4 may be parallel to an axis orthogonal to the third turning axis O3.

The fourth arm 15 and the fifth arm 17 of the wrist 16 are coupled via a joint 175. The fifth arm 17 has a fifth turning axis O5 as a turning center and is capable of turning around the fifth turning axis O5 with respect to the fourth arm 15. The fifth turning axis O5 is orthogonal to the fourth turning axis O4. The fifth arm 17 is turned by driving of the fifth driving source 405 including a motor (a fifth motor) 405M and a reduction gear (not shown in the figure). The motor 405M is controlled by the control device 20 via a motor driver 305. Note that the fifth turning axis O5 may be parallel to an axis orthogonal to the fourth turning axis O4.

The fifth arm 17 of the wrist 16 and the sixth arm 18 are coupled via a joint 176. The sixth arm 18 has a sixth turning axis O6 as a turning center and is capable of turning around the sixth turning axis O6 with respect to the fifth arm 17. The sixth turning axis O6 is orthogonal to the fifth turning axis O5. The sixth arm 18 is turned by driving of the sixth driving source 406 including a motor (a sixth motor) 406M and a reduction gear (not shown in the figure). The motor 406M is controlled by the control device 20 via a motor driver 306. Note that the sixth turning axis O6 may be parallel to an axis orthogonal to the fifth turning axis O5.

Note that the wrist 16 includes, as the sixth arm 18, a wrist main body 161 formed in a cylindrical shape and includes, as the fifth arm 17, a supporting ring 162 configured separately from the wrist main body 161, provided at the proximal end portion of the wrist main body 161, and formed in a ring shape.

In the motors 401M to 406M, first angle sensors 411, 412, 413, 414, 415, and 416 are respectively provided.

In the base 11, for example, the motor 401M and the motor drivers 301 to 306 are housed.

Each of the arms 12 to 15 includes a hollow arm main body 2, a driving mechanism 3 housed in the arm main body 2 and including a motor, and a sealing member 4 for sealing the inside of the arm main body 2. Note that, in the figures, the arm main body 2, the driving mechanism 3, and the sealing member 4 included in the first arm 12 are respectively described as “2a”, “3a”, and “4a” as well. The arm main body 2, the driving mechanism 3, and the sealing member 4 included in the second arm 13 are respectively described as “2b”, “3b”, and “4b” as well. The arm main body 2, the driving mechanism 3, and the sealing member 4 included in the third arm 14 are respectively described as “2c”, “3c”, and “4c” as well. The arm main body 2, the driving mechanism 3, and the sealing member 4 included in the fourth arm 15 are respectively described as “2d”, “3d”, and “4d” as well.

The disposition of the second angle sensor 511 and the angular velocity sensor 31 is explained. Note that, as explained in the first and third embodiments, the second angle sensor 511 for the arm 19 is not set in the arm 19 itself and is set in the base 11 and the reduction gear 501. Therefore, in the following explanation, an expression “the second angle sensor is provided for the arm” is used.

In this embodiment, the second angle sensor 511 is provided for the first arm 12. The angular velocity sensor 31 is provided at the distal end portion of the sixth arm 18. Consequently, it is possible to obtain a necessary and sufficient effect while reducing the number of the second angle sensors 511 and the number of the angular velocity sensors 31.

Note that the second angle sensor may be provided for each of the first arm 12 to the sixth arm 18. The angular velocity sensor may be provided for each of the first arm 12 to the sixth arm 18.

The second angle sensor may be provided for only a part of the first arm 12 to the sixth arm 18. The angular velocity sensor may be provided for only a part of the first arm 12 to the sixth arm 18. The part of the arms may be one arm or a plurality of arms.

According to the fourth embodiment explained above, it is possible to exhibit an effect same as the effect in the embodiments explained above.

The robots, the control devices, and the robot systems according to the embodiments of the invention are explained with reference to the drawings. However, the invention is not limited to this. The components of the sections can be substituted with any components having the same functions. Any other components may be added.

In the invention, any two or more configurations (characteristics) in the embodiments may be combined.

In the example explained in the embodiments, the movable section is the arm of the robot or the manipulator (the robot arm) including the plurality of arms. However, in the invention, the movable section is not limited to this and only has to be a movable portion, that is, a portion capable of moving of the robot.

In the embodiments, the fixing part of the base of the robot is, for example, the floor in the setting space. However, in the invention, the fixing part is not limited to this. Besides, examples of the fixing part include a ceiling, a wall, a workbench, and a ground.

In the invention, the robot may be set in a cell. In this case, examples of the fixing part of the base of the robot include a floor section, a ceiling section, a wall section, and a workbench.

In the embodiments, a first surface, which is a plane (a surface) on which the robot (the base) is fixed is a plane (a surface) parallel to the horizontal plane. However, in the invention, the surface is not limited to this and, for example, may be a plane (a surface) inclined with respect to the horizontal plane or the vertical plane or may be a plane (a surface) parallel to the vertical plane. That is, the first turning axis (the turning axis) is not limited to be parallel to the vertical direction and, for example, may be inclined with respect to the vertical direction or the horizontal direction or may be parallel to the horizontal direction.

In the embodiments, the number of turning axes of the manipulator is one or six. However, in the invention, the number of turning axes of the manipulator is not limited to this and may be, for example, two, three, four, five, or seven or more. That is, in the embodiments, the number of arms (links) is one or six. However, in the invention, the number of arms (links) is not limited to this and may be, for example, two, three, four, five, or seven or more. In this case, for example, in the robots according to the embodiments, by adding an arm between the second arm and the third arm, it is possible to realize a robot including seven arms.

In the embodiments, the number of manipulators is one. However, in the invention, the number of manipulators is not limited to this and may be, for example, two or more. That is, the robot (the robot main body) may be a multi-arm robot such as a double-arm robot.

In the invention, the robot may be robots of other forms. Specific examples of the robot include horizontal multi-joint robots such as a legged walking (running) robot including leg sections and a SCARA robot.

The entire disclosure of Japanese Patent Application No. 2016-124230, filed Jun. 23, 2016 is expressly incorporated by reference herein.

What is claimed is:

1. A robot comprising:
a movable section capable of moving;
a driving section configured to drive the movable section;
a transmitting section located between the movable section and the driving section;
a first position detecting section configured to detect a position on an input side of the transmitting section;
a second position detecting section configured to detect a position on an output side of the transmitting section; and
an inertial sensor provided in the movable section.

2. The robot according to claim 1, wherein the driving section is driven on the basis of a detection result of the first position detecting section, a detection result of the second position detecting section, and a detection result of the inertial sensor.

3. The robot according to claim 1, wherein the inertial sensor is located further on a distal end side of the movable section than the second position detecting section.

4. The robot according to claim 1, wherein, when a first displacement amount of a distal end of the movable section due to deformation of the transmitting section at a time when an external force acts on the distal end of the movable section and a second displacement amount of the distal end of the movable section due to the deformation of the movable section at the time when the external force acts on the distal end of the movable section are compared, the second displacement amount is equal to or larger than 1/30 of the first displacement amount.

5. The robot according to claim 1, wherein an abnormality of at least one of the first position detecting section, the second position detecting section, the inertial sensor, the driving section, the transmitting section, and the movable section can be detected on the basis of a detection result of the first position detecting section, a detection result of the second position detecting section, and a detection result of the inertial sensor.

6. The robot according to claim 1, wherein the movable section includes a plurality of arms.

7. The robot according to claim 1, wherein the transmitting section includes a reduction gear.

8. A control device that controls the robot according to claim 1.

9. A control device that controls the robot according to claim 2.

10. A control device that controls the robot according to claim 3.

11. A control device that controls the robot according to claim 4.

12. A control device that controls the robot according to claim 5.

13. A control device that controls the robot according to claim 6.

14. The control device according to claim 8, comprising:
a low-pass filter provided on an output side of the second position detecting section; and
a high-pass filter provided on an output side of the inertial sensor.

15. The control device according to claim 8, comprising:
a calculating section configured to perform calculation on the basis of a detection result of the second position detecting section and a detection result of the inertial sensor; and
a high-pass filter provided on an output side of the calculating section.

16. A robot system comprising:
the robot according to claim 1; and
a control device that controls the robot.

17. A robot system comprising:
the robot according to claim 2; and
a control device that controls the robot.

18. A robot system comprising:
the robot according to claim 3; and
a control device that controls the robot.

19. A robot system comprising:
the robot according to claim 4; and
a control device that controls the robot.

20. A robot system comprising:
the robot according to claim 5; and
a control device that controls the robot.
